(19) United States
(12) Patent Application Publication
(10) Pub. No.: US 2012/0025950 A1
(43) Pub. Date: Feb. 2, 2012

(54) AUTHENTICATION METHOD AND ARRANGEMENT FOR PERFORMING SUCH AN AUTHENTICATION METHOD AND CORRESPONDING COMPUTER PROGRAM AND CORRESPONDING COMPUTER-READABLE STORAGE MEDIUM

(75) Inventors: M.A. Matthias Von Tippelskirch, Niedergorsdorf (DE); Frank Meissner, Neubrandenburg (DE); Steffen Miske, Waren (DE)

(73) Assignee: ELEGATE GMBH, BERLIN (DE)

(21) Appl. No.: 12/741,470

(22) PCT Filed: Nov. 5, 2008
(86) PCT No.: PCT/EP2008/065010

§ 371 Date: Jun. 9, 2011

(30) Foreign Application Priority Data
Nov. 7, 2007 (DE) 102007053736.2
Feb. 25, 2008 (DE) 102008011518.5
Apr. 22, 2008 (DE) 102008020792.6

(51) Int. Cl. G08B 29/00

(52) U.S. Cl. 340/5.74

(57) ABSTRACT

The invention relates to an authentication method and an arrangement for performing such an authentication method and to a corresponding computer program and a corresponding computer-readable storage medium, said method particularly providing a simple and very cost-effective method for the authentication of persons upon the usage of services with the aid of mobile standard terminals without technical expansions such as RNID equipment or the like. For this purpose, it is provided that in the authentication method a terminal (103) is used, which is equipped with a loudspeaker (109′) and/or color display (109) and special software. In the authentication method, at least one authentication code is generated, first information is provided about the at least one authentication code to at least one user, and second information, which makes the terminal (103) suitable for outputting various tones and/or colors in a time sequence via the loudspeaker (109′) or the color display (109), respectively, is prepared from the first information. A sensor (102, 102′) for detecting the various tones and/or colors detects the time sequence of the various tones and/or colors, and an analysis unit, which is connected to the sensor (102, 102′) and has access to the at least one authentication code, decodes the time sequence of the various tones and/or colors and compares the result of the decoding to the at least one authentication code. The usage of services is released as a function of the comparison result.

The invention relates to an authentication method and an arrangement for performing such authentication method and to a corresponding computer program and a corresponding computer-readable storage medium, with the invention providing a particularly simple and very cost-effective method for the authentication of persons using services with the aid of standard mobile terminals without requiring technical enhancements, such as RFID (Radio Frequency Identification) upgrades or the like.

Mobile telephone terminals have achieved an almost ubiquitous prevalence. They are therefore suitable to establish a standard for the transmission of changing access and usage information, provided that the user is able to use the system cost-effectively and, more particularly, cost-transparently.

Standard functions in the context of this description include for the conventional, commercially available mobile telephone terminals components which emit or receive sound waves (sound transponders, typically loudspeaker and microphone), color displays, keypads and the ability to load software into the non-volatile memory, to execute the software therefrom and to thereby provide additional functionality.

Known in the art are the standardized methods NFC (Near Field Communication, for example about 10 cm range at 13.56 MHz, 424 kb/sec, communication among active devices and between active devices and passive components) and RFID (Radio Frequency Identification, different configurations with ranges from 1 cm to several meters, frequency ranges of LF, HF to UHF, microwave frequencies, communication exclusively of activating devices with passive tags).

Several conventional solutions are known in the technical field of the invention, which provide contactless data transmission, for example barcodes, and a corresponding barcode reader. As disclosed in the German published patent application DE 100 34 275 A1, the barcode can be displayed on the display of a mobile telephone terminal.

Another authentication method is disclosed in the published application DE 101 64 574 A1. In the solution described therein, an operator of a goods lock deposits goods in this goods lock and generates a code for opening the goods lock. The operator of the goods lock subsequently transmits this code to a person authorized to open the goods lock, who then transmits this code to the goods lock via an interface of a portable mobile terminal for opening the goods lock.

Another method for releasing merchandise or unblocking a service is described in the published patent application DE 199 34 981 A1, wherein a first communication link is established between a mobile telephone terminal and a device for dispensing merchandise and a second communication link is established between the mobile telephone terminal and a service computer. The first communication link is used to select the desired merchandise or service, while the second communication link is used for billing of the selected merchandise or service.

The utility model DE 20 2004 013 762 U1 describes an electronic ticket which can be displayed on the display of a mobile terminal and which includes a control code in form of a predetermined sequence of symbols. This control code can be checked by a person or automatically by a control apparatus. This solution has the disadvantage that special devices are required for detecting a sequence of symbols.

It is therefore an object of the present invention to provide an authentication method and an arrangement for performing such authentication method as well as a corresponding computer program and a corresponding computer-readable storage medium, which obviate the disadvantages of the conventional solutions and more particularly require only simple components, preferably standard components, for carrying out the authentication code.

This object is attained according to the invention with the features recited in claims 1, 17 and 29 to 31. Advantageous embodiments of the invention are recited in the dependent claims.

According to a particular advantage of the invention, in a first embodiment of the invention only a conventional terminal with a microphone and a loudspeaker, standard data processing devices, and a simple acoustic sensor for receiving sound waves are required for its execution. In this first embodiment, acoustic signals in form of different combinations of sound waves are generated from an authentication code. According to a second embodiment of the invention, optical signals in form of different colors are generated from the authentication code. For implementing the second embodiment, only a conventional terminal with color display, standard data processing devices and a simple optical sensor for detecting the different colors are required. It will be understood that both embodiments may be combined and implemented with a conventional terminal having a microphone and loudspeaker, a color display, standard data processing devices and simple acoustic and optical sensors for receiving sound waves and/or colors. According to a preferred embodiment of the invention, both signal forms—acoustic and optical—may be used in combination, either simultaneously or successively, preferably with the same terminal. All method steps, which will be described hereinafter for one of the two signal modes, can therefore also be carried out for the other of the two signal modes or for both signal modes in combination.

According to the invention, at least one authentication code is generated by a unit. This unit may be, for example, a service provider, a vendor or another entity offering services. The unit may also be at least one data processing device, with which the vendor, the service provider or the other entity providing services can cause the at least one authentication code to be generated automatically. After generating the at least one authentication code with the unit, information concerning the at least the at least one authentication code is provided to one or several users. If the authentication code is not associated with a particular person, as may be the case for access authentication to an event, information can be provided to several users by using the same authentication code. If the authentication code is associated with a particular person, only that one user gains access to the particular authentication code. To have an authentication code assigned, an application from the user intending to use the services provided by the unit may be required. In one particular embodiment, such application is generated by having the user provide to the unit the data required for the application. Preferably, a central computer system is used by the unit for administering the data, which forms a part of the at least one data processing device and includes one or several servers. The central computer system administers in addition to the user data preferably also, for example, the authentication code and the utilizable services. In one preferred embodiment of the method of the invention, a user enters his/her data in a web browser during the application process or when requesting a service. The unit preferably provides a website, preferably via the central computer system, with a corresponding input mask. The data entered by a user include, for example, information identifying the user, such as personal data and a password, account information, an identifier to be used for contacting the terminal, and/or the desired services. After a user has registered and has requested a service provided by the unit, for example by transmitting the identifier of his/her terminal and the desired service, to the unit, the unit generates an authentication code which the user displays for legitimizing access and using the service. In a preferred embodiment of the invention, the at least one authentication code and/or information about at least this at least one authentication code is automatically transmitted by the unit, for example by using the central computer system, to the identifier provided by the user.

Special software, which processes the authentication code and/or the information about at least the authentication code, is installed on the terminal of the user, whereby data are generated which allow the terminal of the user to time-sequentially emit with the loudspeaker sound waves with different frequencies and/or to time-sequentially display different colors on the color display.

With this special software, the authentication code itself is converted into a sequence of sound wave combinations (tones) in the frequency range of audible tones, but also in the infra-sound and ultrasound range from several tenths of a Hertz to about 100 kHz, which are emitted by the loudspeaker or converted into a color sequence and displayed on the color display, when the user must be legitimized for the desired service. Alternatively or in combination, legitimization may be attained by having the special software itself convert the authentication code into a color sequence which is then displayed on the color display. The special software can also process the information about the at least one authentication code alone or in combination with the transmitted authentication code, in order to generate the sequence of sound wave combinations and/or the color sequence corresponding to the authentication code, which can then be outputted by the loudspeaker and/or the color display as needed.

The invention includes also a sensor (acoustic sensor) for detecting the various sound wave combinations emitted from the loudspeaker and/or a sensor (optical sensor) for detecting the different colors displayed on the color display. The acoustic sensor may be, for example, a simple microphone with a connected memory or processing unit, or a complex device, such as a conventional telephone equipped with IP transmission technology (“IP telephone”) which is generally known in the field of telecommunication. The optical sensor may be, for example, a CCD (Charge-Coupled Device) or a (digital) camera or a simple color-sensitive light detector. Such color-sensitive light detector may be an integrated circuit which only indicates the presence of light, without additional image information. These sensors are preferably used by vendors and service providers to check if the user intending to use their services is legitimate. To this end, the sensor or sensors include means for data exchange with at least one processing unit, which has access to the authentication codes generated by the unit. For authentication, the user positions the loudspeaker and/or the color display of the terminal in the region captured by the sensor, and starts a program which time-sequentially outputs the different sound wave combinations with the loudspeaker and/or the different colors on the color display. The authentication code is defined by a particular sequence of different sound wave combinations and/or colors. Such tone and/or color sequence defining the authentication code can also be called a cycle. The cycle may be performed only once or several times in succession. The sound wave combinations and/or colors representing the authentication code may also be outputted sequentially in discrete steps, or the corresponding sound wave combinations and/or colors may change into one another gradually and continuously.

Depending on the type of the sensor, the sensor detects the sound waves emitted from the loudspeaker and/or the colors displayed on the color display, and transmits the corresponding signals to the at least one evaluation unit which evaluates and decodes the signals. Decoding produces a signal sequence which is then compared with the authentication code generated by the unit. If a corresponding authentication code is identified, the user is legitimized and the service is unblocked.

In a particular embodiment, the special software installed on the terminal encodes in addition to the authentication code additional data and outputs the data through the loudspeaker or on the display as sequence of different sound wave combinations and/or as a sequence of different colors. The sound wave combinations and/or colors associated with the authentication code and with the additional data can then be outputted directly sequentially during one cycle or during several separate cycles. The additional data may relate to data required for transactions, for example passwords or transaction numbers (TAN) for bank transactions.

According to one embodiment, the sound wave combinations are calculated as a function of one or more characteristic quantities. These characteristic quantities go into cryptographic processing. After predefined brief time intervals, the calculation of the sound wave combinations is changed, so that eavesdropping on the data transmission cannot result in undesirable actions due to a misappropriated code. Cycles typically change over times ranging from several seconds to several hours or even days.

An arrangement for carrying out the authentication method according to the invention includes at least one data processing device, at least one terminal equipped with a loudspeaker and/or a color display, and at least one sensor for detecting sound wave combinations and/or at least one sensor for detecting colors. In a preferred embodiment, the at least one data processing device includes a central computer system which may include one or several computers. The components of this arrangement are at least temporarily connected by means for data transmission. According to the invention, the apparatus is configured such that authentication codes and data describing the useful services are stored in the at least one data processing device. The data describing the available services may be provided to the at least one data processing device by the respective vendors or service providers. The operator of the apparatus according to the invention and the vendor or service provider may be one and the same entity. However, they can also be different entities. An authentication code is preferably generated by a program installed on the at least one data processing device when a user requests a particular available service. In another preferred embodiment, the generation of authentication codes is related to additional actions. For example, an authentication code may only be generated after payment of the service has been confirmed or after a requested identifier, such as for example a password or a TAN, has been entered correctly.

For registering users or for purchasing or booking of services, the arrangement of the invention is connected via a communication link to an input device, for example a PC, a notebook, a mobile telephone or other Internet-enabled data processing devices. The arrangement provides here an Internet page with a corresponding input mask, which can be controlled via a browser displayed on a display of the Internet-enabled data processing device.

After an authentication code has been generated, this code is transmitted from the at least one data processing device to a terminal designated by the user. This can be done by using a Short Message Service (SMS) or by sending an e-mail. The terminal to which the authentication code is transmitted is preferably a mobile terminal. Particularly preferred are mobile terminals, such as mobile telephone, PDA (Personal Digital Assistant), notebook and the like. Information about the authentication code can be transmitted to the terminal instead of the actual authentication code or together with the actual authentication code.

When the authentication code or the information about the authentication code are received at the terminal of the user, the authentication code or the information about the identification code is processed with special software installed on the terminal of the user, wherein this processing generates data which cause the loudspeaker of the terminal to time-sequentially output a different sound wave combinations and/or to time-sequentially display on the color display of the terminal different colors. These outputted time-sequential sound wave combinations and/or color sequence represents at least the authentication code. The authentication code is hence encoded into a time sequence of sound wave combinations and/or colors. The authentication code itself, however, may be stored in a different type of representation in the various data processing devices involved in the authentication process of the invention, for example in form of ASCII symbols (ASCII=American Standard Code for Information Interchange) which represent letters, numbers and/or special symbols. The authentication code received at the terminal of the user or the information about the authentication code can be processed immediately after the data are received on the terminal or later in response to a corresponding user input. This encoding can generate a sequence of sound wave combinations and/or a color sequence, wherein a single sound wave combination and/or a single color is associated with each symbol represented in ASCII code, i.e., all seven bits of the symbol; alternatively a dedicated sound wave combination and/or a dedicated color can be associated with each of the seven bits of an ASCII code (or generally: with each element of an authentication code). Moreover, packed data formats, such as binary stored numbers or packed BCD (packed binary coded decimal), can be used for numerical information, wherein once more sound wave combinations and/or colors can be associated with the resulting byte codes. In one potentially important form of encoding, a sound wave combination and/or a color is not associated with the codes or the individual elements of a code themselves; instead, a distance between the individual elements of the code, for example between one element and its predecessor, enters the code, so that a uniform distribution or a change of the code of the sound wave combinations and/or the color code is achieved even if consecutive symbol codes (ASCII or packed formatting) remain unchanged. According to another preferred embodiment of the invention, the at least one authentication code is encoded as changes of the sound wave combinations and/or as changes in the colors in the time sequence. With such encoding based on a relative frequency difference of the sound wave combinations and/or of the color difference, decoding errors caused by differences in the rendition the sound wave combinations via different loudspeakers or differences in color rendition on different color displays can generally be avoided with such encoding. In certain situations it may be advantageous to encode the at least one authentication code with absolute frequency values of sound wave combinations and/or with absolute color values.

According to another embodiment, an apparatus is configured to form the authentication code used for identification or unblocking by using spoken words, parts of words, collocations and/or sentences, or general acoustic signals. These words, word parts, collocations, sentences or acoustic signals are inputted in the apparatus via means for inputting acoustic signals, for example a microphone, and are converted by data processing means provided by the apparatus into the authentication code. This arrangement advantageously eliminates the need for input via keyboard and the like typical a conventional man-machine interface, all of which is enhanced and facilitated by using the devices for sound recording already installed in mobile telephone terminals.

With the aforedescribed embodiment, an authentication code can be generated on a commercially available mobile terminal. In the applications considered to date the authentication code is exclusively produced by the central system.

The definition of the authentication code on the mobile terminal becomes feasible because the described method does not use keyboard input or already existing or even predefined data as a basis for forming the authentication code. Upon request by the program stored on the mobile terminal, the user speaks a short phrase into the microphone installed in the mobile terminal. The recorded sound waves are scanned in the mobile terminal, converted into a computer-readable data and stored as a file. The spoken words, the individual tone and different environmental conditions make these data unique. The authentication code is computed from these unique data. The generated authentication code or parts thereof, which are deduced and secured by cryptographic methods, are transmitted to the central server. The authentication code is then used in the aforementioned manner on the mobile terminal to initiate one of the aforedescribed actions.

This arrangement is particularly advantageous in user-friendly application systems. Particular secure authentication codes which are unique and sufficiently long can be generated without requiring an untrained user to perform keyboard input or other burdensome user operations.

To obtain a service from a service provider by using authentication with sound wave combinations, the arrangement of the invention is used as follows. The user positions the terminal in the area where the sensor is able to detect sound waves sent by the terminal. Likewise, a terminal which (also) has a loudspeaker, is moved into the area where the sensor detects colors, so that the colors on the color display of the terminal can be detected by the sensor. In this position, the various sound wave combinations and/or the different colors are outputted time-sequentially via the loudspeaker and/or on the color display of the terminal. The sound wave combinations and/or colors outputted by the color display are detected by the respective acoustic or optical sensor and transmitted to an evaluation unit connected to the sensor by means for data exchange, wherein the evaluation unit evaluates the transmitted signal and determines the authentication code by decoding the different time-sequentially outputted sound wave combinations and/or colors. The evaluation unit which evaluates the transmitted signals and restores the authentication code by decoding the time-sequentially outputted different sound wave combinations and/or colors has access to the authentication codes generated by the unit and stored in the central computer system. In a preferred embodiment, the evaluation unit is part of the at least one data processing device or part of the central computer system, and the sensors for detecting the sound wave combinations and/or colors are connected via means for data exchange with the at least one data processing device or with the central computer system. The evaluation unit has hence access to these authentication codes and compares the authentication code obtained by decoding the sequence of the sound wave combinations and/or by decoding the color sequence with the authentication codes generated by the at least one data processing device and causes unblocking of the required service if predetermined comparison criteria are met.

The arrangement therefore represents a system where a terminal, preferably a mobile telephone terminal, cooperates via the loudspeaker and/or the display with receiving devices, i.e., (acoustic and/or optical) sensors, such as sound receivers or color sensors. For an operation, for example for using a service, an authenticating identifier is transmitted from the mobile telephone terminal to the receiving device. This identifier may include general information which rarely changes as well as a single-use transaction number.

Unlike other solutions, the data set to be transmitted are variable because of the serial nature of the information. There is no need to transmit a defined, fixed and unchanging data set, unless required by the type of information, for example with 2D barcodes, which must always be read completely, which implies a certain data set. With the proposed method, the quantity of data to be transmitted depends only on the quantity of the actually transmitted information.

The mobile telephone terminal receives the information to be forwarded to the receiving device ahead of time via standard services, such as SMS, or also via data communication, such as setup of a network connection typical with the Internet (IP network or similar) via UMTS or GPRS or other GSM services of the mobile telephone network operators.

With the system, information can be transmitted from the mobile telephone terminal to the receiving device without any physical contact via frequency changes of sound wave combinations from the loudspeaker of the mobile telephone terminal and/or via color changes on the display of the mobile telephone terminal. The information can be recorded with special sensors, for example with moving-coil microphones for acoustic signals with downstream storage or processing units, or other suitable modules, such as piezoelectric elements. With optical information transmission, color-sensitive light detectors or other suitable modules, such as CCD line sensors or cameras, can be used as sensors. The color changes can occur over the entire area or only in certain geometric or other system-specific arrangements. In a preferred embodiment, a predefined unclocked encoding scheme of the sound wave combinations and/or of the colors is used in conjunction with an automatic threshold adjustment to enable secure data transmission from any type of mobile telephone terminal under different environmental conditions.

One advantage of the system is the use of very inexpensive (sensor) or readily available (built-in microphone or camera) receiving devices. In addition, the mobile telephone terminals preferably use only generally available standards: loudspeaker (and microphone), color display, telephone keypad, SMS service.

The “optical” system can also be employed by having generally available displays, including parts of TV monitors, monitors in publicly accessible facilities, computer monitors, etc., display the information and by having mobile telephone terminals read this information, for example with a built-in camera.

In an analogous manner, the “acoustic” system can be employed by having generally available sound generators, including parts of television sets, loudspeakers in publicly accessible facilities, computers with connected sound devices, etc., render the information and by having mobile telephone terminals read this information, for example with the built-in microphone.

Communication between two mobile telephone terminals can be configured in a similar manner. In addition, the same concept can be used by combining the aforementioned standard loudspeakers, microphones and/or standard displays with special receiving devices.

The system is suitable, for example, for securing access for regularly used facilities, for example offices of an organization or technical equipment, such as computers, and for access control for one-time events, for example theater performances or one-time access to technical services, such as rental cars.

Secure systems can be implemented by using cyclically changing computing algorithms, although eavesdropping may not be preventable under all circumstances during transmission of the code. A code obtained by eavesdropping becomes useless for later use due to the cyclic change. One example is the use of access codes for door locks or the input of personal identification codes (PIN) in plain view at bank terminals.

According to one advantageous feature of the system, the user must be in close proximity of the terminal and the receiving unit must be physically placed in protected surroundings according to standard practice.

The system is implemented by arranging several computers and communication devices. Preferably, a central server takes over management of the user data and optionally also of the transaction data.

In a preferred embodiment, the user stores his/her data, optionally the telephone number of his/her mobile telephone terminal and the desired services, via web browser on the central server. For some services, authentication of the user is only implemented with third parties. In addition, transaction-related services are envisioned.

Software which processes the information on the device is installed on the mobile telephone terminal. When data intended for the aforedescribed system and qualified by way of the telephone number or the IMEI (International Mobile Equipment Identity) code of the mobile telephone terminal, are received on the central server, for example via SMS, the codes for using the services are computed therefrom. Codes are rarely transmitted for authentication services; preferably, the frequency and data for changing, for example, the code are exclusively centrally determined. Transaction services send the codes depending on the situation, for example immediately after a booking.

When the user wishes to apply the received code, he/she must keep the mobile telephone—even without a connection to the mobile network—available, and the user must select via a menu the desired code and place the loudspeaker within a distance of several centimeters, or the display within a distance of several millimeters, from the receiving device. The receiving device will perform the desired action within a short time. Before being able to use the mobile terminal, the user had to identify his/her mobile telephone terminal by a PIN stored on the SIM card. All information stored in the memory of the mobile telephone terminal or programs executed from the memory can only be used by the user who knows the PIN of the used SIM card to be entered when the device is turned on, or otherwise in regular intervals. This guarantees that with a secret PIN, all stored information for using the proposed method is kept confidential, thereby preventing unauthorized use of services if the mobile terminal is lost. Securing SIM cards with a PIN preferably involves the use of accepted secure cryptographic methods.

With the invention, confirmations relating to bookings, use of services, code changes for authentications (time-controlled with selectable frequency or event-controlled depending on the use) can be implemented via services at no cost to the user, such as SMS reception. In this way, a large number of users can be recruited for these services. Alternatively, data communication is possible via mobile telephone networks, thus enabling significantly faster transmission. Commercially feasible models can be implemented by exchanging the communication layer, without requiring changes to the software.

In a low-cost variant, Web registration for desired services may be performed via wired Internet and the like, whereas the business variant will likely rely on booking via mobile Internet connections.

According to one advantageous embodiment of the invention, the central server may be connected with several other, already existing or newly implemented services by incorporating the required data from other providers and forwarding the data to the central server for processing. This eliminates duplication of user interactions.

In an advantageous embodiment of the system, a low-cost sensor can be used with the receiving devices. The sensor opening can be practically implemented (several millimeters diameter, cover made of resistant, sound-permeable and/or transparent materials, printing of the visible region), so that the system can also be readily used in public without requiring further explanation from the user. In addition, devices with particular protection (e.g., explosion-proof) may be used, which only requires suitable hardware, but no other changes of the system.

In an advantageous embodiment of the aforedescribed system, two mobile telephone terminals may be configured to communicate via a loudspeaker and microphone, or via the display and the frequently already installed cameras. Authentication codes and any other information, which describes or enhances or is otherwise related to the authentication codes, may then be exchanged between two mobile terminals without requiring central services and computers. In this way, for example, payments between mobile telephone terminals can be processed or authentications can be implemented exclusively between mobile terminals. The mobile terminal hereby becomes an identification tool with respect to other mobile terminals which is implemented by way of the proposed method. In this embodiment, the two mobile terminals operate alternatingly as terminal with loudspeaker for outputting the authentication code and as acoustic sensor coupled to an evaluation device (preferably integrated in the mobile terminal) for evaluation and decoding of the authentication code. If the authentication code is optically encoded, both mobile terminals operate alternatingly as a terminal with color display for displaying the authentication code and as an optical sensor.

The microphone and/or the camera of a mobile telephone terminal can also be used to receive processed information from other sound sources and displays, respectively. These may be, for example, promotion codes, booking codes, advertising or price information.

The use of secure certification on all devices involved in the communication is required in the same way as the securing the mobile telephone terminal with a PIN and storing it in a secure place.

With the invention, a system providing a universal access check to various services is provided. A central server is used for central control of the user activities. At least the user data and information about available services are stored on a central server. The central server cooperates with the terminal of the user, on one hand, via standard mobile telephone services, such as SMS, and on the other hand, via a special, but very inexpensive sensor (receiving device). To cooperate with a central server, the terminal of the user communicates with the sensor by transmitting sound information and/or color information from the terminal to the respective acoustic or optical sensor. Advantageously, a standard terminal equipped with a loudspeaker and/or color display and with capabilities to execute software is employed, because such terminal does not require hardware modifications.

Preferably, identification features of the mobile telephone terminal (IMEI, additionally storage of certificates and safeguarding via PIN) are transmitted to the sensor for authenticating the user with respect to the sensor and/or indirectly with respect to the central server.

The system of the invention can automatically control access by unblocking, for example turnstiles or door openers. However, the system can also be used to register access with a central server, in conjunction with data collection for optional fee processing or only for verification.

The system of the invention can advantageously be enhanced with microphones, which are necessarily integrated in the terminal, and/or cameras which are advantageously integrated in the terminal, in order to be able to receive data from acoustic and/or visual output means (loudspeaker or other audio sources or optical devices, or other video sources) connected to the central server. These data may include general or special codes which may then be further processed in the terminal.

According to another advantageous embodiment of the invention, the central server and the sensor may be combined in a terminal, preferably in a mobile terminal, with communication between this terminal and a second terminal carried out with loudspeakers and microphones and/or cameras and color displays, which are advantageously integrated in each terminal. In a preferred embodiment, at least one of the terminals include software for reconciling the data between the two mobile telephone terminals, in addition to reconciling payment, credit or debit values.

According to another preferred embodiment of the invention, devices are provided with an acoustic and/or optical sensor and a sound source, preferably a standard loudspeaker, and/or a display, preferably a standard display, as input and output means. In all other aspects, the device lacks control components. This device according to the invention is also connected with a central server. The system according to this embodiment is also provided with software for operating the device through mediation by the central server, whereby the device is controlled via the keyboard of the terminal as input medium. The microphone or display of the terminal transmits the input data time-sequentially via different sound wave combinations and/or via different colors to the acoustic or optical sensor of the device. In a particularly advantageous embodiment, the device to be operated is located in a physically secure environment, or the sound source, display and sensors of the device to be operated are located in a physically secure environment. Advantageously, the microphone of the terminal can be used. Moreover, the terminal is advantageously provided with a camera. The microphone integrated in the terminal and/or the camera integrated in the terminal operate as an information sink, whereas a sound source or parts of the display of the device to be operated operate as an information source for the sound wave-based and/or color-based data transmission according to the invention.

According to another advantageous embodiment of the invention, the method of the invention can also be used without a permanent server connection, for example by connecting the central server with the sensor only temporarily. Enhanced cryptographic methods are then preferably used to attain secure communication.

A computer program for executing the authentication method according to the invention enables a data processing device, after the program has been loaded into the memory of the data processing device, to carry out an authentication method, wherein at least one data processing device cooperates at least temporarily with at least one terminal and with at least one sensor via data transmission means, and wherein at least one authentication code is generated, wherein first information about the at least one authentication code is provided to at least one user, wherein second information is generated from the first information which enables the terminal to time-sequentially output sound wave combinations via the loudspeaker and/or to display time-sequentially different colors on the color display, wherein an (acoustic) sensor for detecting the different tones detects the time sequence of the different sound wave combinations and/or an (optical) sensor for detecting the different colors detects the time sequence of the colors, wherein an evaluation unit, which is connected with the acoustic and/or optical sensor and has access to the at least one authentication code, decodes the time sequence of the different sound wave combinations and/or the different colors and compares them with the at least one authentication code, and wherein the utilization of services is unblocked depending on the results of the comparison.

According to a preferred embodiment of the invention, the computer program of the invention has a modular structure, wherein individual modules may be installed on different data processing systems.

Such computer programs may be made available, for example, for downloading in a data or communications network (for a fee or free of charge, unrestricted or password-protected). The provided computer programs can be used by a method, wherein a computer program according to claim 29 is downloaded from an electronic data network, for example from the Internet, to a data processing system connected to the data network.

To carry out the method of the invention for authentication, a computer readable storage medium may be employed, on which a program is stored which enables a data processing system, after being loaded into the memory of the data processing system, to carry out an authentication method, wherein at least one data processing device cooperates at least temporarily with at least one terminal and with at least one sensor via data transmission means, and wherein at least one authentication code is generated, wherein first information about the at least one authentication code is provided to at least one user, wherein second information is generated from the first information which enables the terminal to time-sequentially output sound wave combinations via the loudspeaker and/or to display time-sequentially different colors on the color display, wherein an (acoustic) sensor for detecting the different tones detects the time sequence of the different sound wave combinations and/or an (optical) sensor for detecting the different colors detects the time sequence of the colors, wherein an evaluation unit, which is connected with the acoustic and/or optical sensor and has access to the at least one authentication code, decodes the time sequence of the different sound wave combinations and/or the different colors and compares them with the at least one authentication code, and wherein the utilization of services is unblocked depending on the results of the comparison.

Particular advantages of the invention are:
only standard components are used in the preferably mobile terminals,
the sensors for detecting sound waves or color are particularly inexpensive, have no moving parts and can be adapted in different ways to the environment and protected, for example with sound-permeable or transparent materials, from physical access by unauthorized users,
the communication via sequences of sound wave combinations and/or color sequences makes eavesdropping on the information particularly difficult,
the use is very uncomplicated for the user,
the use by the user can be inexpensive, so that widespread use can be expected,
the use can be made comfortable so that the invention is expected to be accepted for business models and commercial use, and
a large number of applications enables widespread use of a uniform system.

The invention will now be described with reference to several exemplary embodiments illustrated in the drawing, in which.

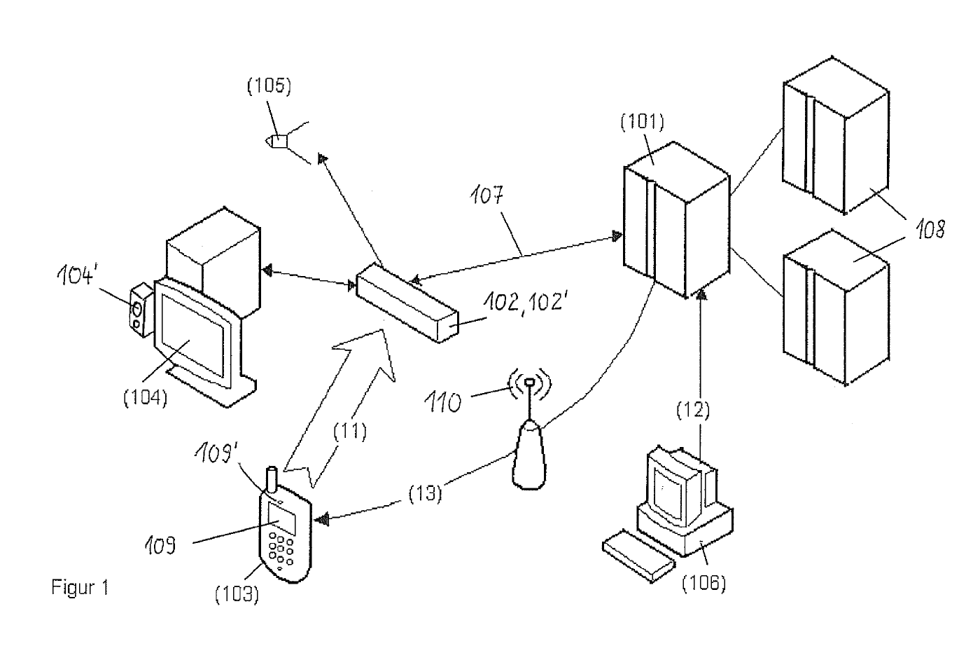

FIG. 1 is a schematic diagram of the components of an exemplary system for carrying out the authentication method, as well as the cooperation of the employed components.

The exemplary system includes a central server 101, a sensor 102 and a terminal 103 with a color display 109. For example, a mobile telephone terminal may be used as a terminal 103. In this exemplary system, the central server 101 takes over the management of the user data and optionally of the transaction data.

Although the invention is described based on an example of encoding the authentication code as a color sequence, the invention is not limited to this exemplary embodiment. In particular, the color display 109, the optical sensor 102 and the time-sequentially outputted color sequence may be replaced by a loudspeaker 109′, an optical sensor 102′ (e.g., a microphone), and the sound wave combinations outputted time-sequentially by the loudspeaker. Other embodiments may be contemplated which employ a combination of these features and encode authentication codes both as a color sequence and as a tone sequence. The authentication code may be encoded entirely as a color sequence or as a tone sequence. Alternatively, the authentication code may be encoded partially as a color sequence and partially as a tone sequence. Additionally, the color sequence and the tone sequence for authentication may be outputted simultaneously or consecutively.

To use the exemplary system, a user registers with the central server 101, for example via wired access 106. The user can transmit via the wired connection 12 various registration data, for example a desired service (e.g., booking a ticket) and the telephone number of the terminal 103 to be used later for retrieving the service.

After receipt of the registration data, the central server 101 generates for a user an authentication code to be used by the user for legitimization and for utilizing the service. In an exemplary embodiment, the generated authentication code is transmitted per SMS in a wireless network 110 from the central server 101 to the terminal 103 via a first communication link 13. Alternatively, this transmission can also occur via GPRS (General Packet Radio Service) or via e-mail. After the authentication code is transmitted and available on the terminal 103, it is processed by special software installed on the terminal 103. As a result of the processing, the data for time-sequentially outputting the different colors (color sequence) on the color display 109 are generated. In this exemplary embodiment, the authentication code is encoded in the color sequence such that the authentication code is determined by the colors alone, i.e., the duration during which a certain color is displayed on the color display 109 is immaterial for encoding/decoding. Alternatively, the duration during which a color is displayed on the color display 109 can also be taken into account for encoding the authentication code. Likewise, the duration during which a certain sound wave combination is outputted by the loudspeaker, may or may not be taken into consideration.

In the exemplary embodiment, the entire surface of the color display 109 may be used for outputting the different colors. Alternatively, only a portion of the color display 109, for example a certain geometric pattern such as a circle, rectangle and the like, may be provided as output area. In this way, several colors can be displayed simultaneously on the display, which improves the transmission speed by increasing the simultaneously transmitted information, or which improves the security of the transmission by explicitly delimiting patterns.

In the exemplary embodiment that uses sound wave combinations instead of color sequences, the frequency, and optionally a mixture of frequencies for defined frequency bands can be used as an alternative criterion, instead of the computation of tone frequencies or the output duration. Superpositions for checking and securing the transmission can be used by employing suitable modulation methods. Several discrete tones can be outputted simultaneously, which not only improves the transmission speed, but also provides explicitly patterns for improving the security of the transmission.

When the user wishes to utilize a service for which the user received the authentication code, the user positions the color display 109 in close proximity to the sensor 102 and begins outputting the authentication code. The authentication code is here visualized on the color display 109 of the terminal 103 as a sequence of different colors, and the data stream of the color sequence is transmitted contactless from the color display 109 to the sensor 102 via a line of sight link 11 (if using a sound wave combination, via an acoustic link).

In the exemplary embodiment, the sensor is connected to the central server 101 via a second communication link 107, for example via a mobile telephone data link, LAN, a serial connection and the like. The sensor data are transmitted via this second communication link 107 to the central server 101 where they are evaluated. Evaluation in the context of this exemplary embodiment includes automatic threshold adjustment and decoding of the sensor signals for retrieving the authentication code. The authentication code retrieved with this evaluation is compared with other authentication codes stored on the central server 101. Alternatively, the sensor may also be equipped with its own evaluation unit, so that the evaluation can be performed at the location of the sensor 102. To check the authentication code obtained by the evaluation unit, the evaluation unit only requires access to the authentication codes administered by the central server 101. The tasks required for the evaluation and comparison may also be divided differently between the evaluation unit and the central server 101.

The color sequence may include other information in addition to the authentication code. This additional information may include, for example, passwords of the user, the IMEI code or the PIN of the terminal 103 and the like.

The decoded data, meaning the authentication code and optionally the additional information, are subsequently compared with the data administered by the central server 103. The service requested by the user is unblocked for a positive result of the comparison, for example a door opener 105 is controlled to unblock entry.

Many other services can be provided by the system of the invention. In another exemplary embodiment, the central management system includes, for administering the various services, in addition to the central server 101 additional data processing systems 108 which are connected with one another at least temporarily by way of data communication means.

When applying the invention, at least three fundamental situations need to be distinguished: simple authentication, business transaction, and bidirectional data transmission.

### 1. Authentication

Access control to places, leased parking spots: terminal 103 is identification; visualization of the access code on the display is here used for unblocking doors;

Time registration: terminal 103 is identification; visualization of the employee code on the display is used for registration at the terminal;

Computer access simple: receiving device controls employee code;

Computer access complex, also remote: a key portion 1 is displayed on the display 104, preferably a standard display, of a computer, preferably in form of a color sequence according to the invention; terminal 103 records the key portion 1 with a camera, computes a key code 2 based on a certificate and returns the key code 2, preferably as a color sequence according to the invention, to the computer, which unblocks access (also usable for other processes) (as mentioned above, when utilizing sound wave combinations, visualization on the display can be replaced by sound representation, camera by microphone and color sequence by tone sequence);

WLAN-Hotspot: terminal 103 is identification;

Identification with customer loyalty systems (Shopping Card): terminal 103 is identification;

Payment confirmation for credit and debit cards, or also with automated teller machines and “cyber payment”: terminal 103 is identification;

Ticket systems for standard rides: rapid transit with pass, one fare zone, bicycle rental, etc.: terminal 103 is identification as booking confirmation when boarding.

### 2. Transaction Processing

Ticket systems for expensive trips, one-time events, and other bookings: theater, movies, etc., rail, bus or airline travel, rapid transit systems with several tariff options, parking garages: terminal 103 is identification as booking confirmation at automated machines;

Ticket systems free of charge, but promotion-based, one-time accessible systems, such as for example raffles at large fast food chains, with one-time participation in the drawings in each promotion, through identification at the counter with the terminal 103 and the promotion ID available in the Internet. After authentication or after an authentication attempt, the authentication code is deactivated in the system.

3.More complex data transmission

The terminal 103 may become an authenticating input medium for contactless (remote) control devices. To this end, the device to be operated includes as input means only a sensor 102 as an input device according to the aforedescribed system; mouse, keyboard etc. are not required. The device to be operated also includes a display 104, preferably a standard display. A user will initially register with his/her authentication code. The display 104 of the device to be operated may generate (a) a user-readable visualization or, as described above (b) a machine-readable output in form of a color sequence. In the case (a), the terminal 103 receives additional input and then transmits the data in the aforedescribed manner in form of a color sequence to the device which reads the color sequence, for example with a color sensor. In the case (b), the camera installed in the terminal 103 is able to read the information directly. The software on the terminal 103 will then control further processing. Devices with standard components, but without mechanically movable or sensitive parts (touch-sensitive displays), can be securely operated in this way, even if these devices must be operated in sensitive surroundings (public places; secure sites).

If a sound wave combination is used, a user will initially also register with his/her authentication code. The acoustic converter 104′ of the device to be controlled may generate an aforedescribed machine-readable output in form of a tone sequence. The terminal 103 may receive additional inputs, wherein the terminal 103 transmits the data in the aforedescribed manner in form of a sequence of sound wave combinations to the device which reads the sequence for example with a microphone. Alternatively, operating instructions may also be displayed on a standard display associated with the device to be controlled. The terminal 103 is then manipulated with the standard keyboard so that the software can generate sequences of sound wave combinations as control information for the device to be controlled.

In another example, data in form of a color sequence displays 104 may be received in the aforedescribed manner from terminals 103 having a built-in camera. These data may include, for example, promotion codes, advertising data, order information. The data can then be utilized by the user directly for order processing either at special access points by way of the aforedescribed sensors 102 (preferably inexpensive receivers) or per SMS transmission, data communication, and the like.

The invention is not limited to the exemplary embodiment described above. Instead, additional modified embodiments may be realized through combination and modification of the aforementioned means and features, without going beyond the scope of the invention.

### LIST OF REFERENCES SYMBOLS

11 Line of sight link
12 Wired connection
13 First communication link
101 Central server
102 Sensor
102′ Sensor
103 Terminal
104 Display
104′ Sound transducer
105 Door opener
106 Access to wired network
107 Second communication link
108 Data processing system
109 Color display
109′ Loudspeaker
110 Wireless network

1-31. (canceled)

32. An authentication method, comprising the steps of:
generating at least one authentication code,
providing first information about the at least one authentication code to at least one user,
generating from the first information with special software installed on a terminal second information which enables the terminal to time-sequentially output different sound wave combinations via a loudspeaker or time-sequentially display different output colors on a color display, or both,
detecting with a first acoustic sensor the time sequence of the different sound wave combinations or with a second optical sensor the time sequence of the different colors, or both,
decoding with an evaluation unit, which is connected to at least one of the first acoustic sensor and the second optical sensor and has access to the at least one authentication code, the time sequence of the different sound wave combinations or colors, and comparing a result of the decoding with the at least one authentication code, and
unblocking use of services depending on an outcome of the comparison.

33. The authentication method according to claim 32, wherein the first information is made available to the at least one user via e-mail or by using a Short Message Service (SMS), via a download in a communication network, or as sound or color information from an output device, or a combination thereof.

34. The authentication method according to claim 32, wherein the different sound wave combinations comprise simultaneously transmitted different tone frequencies or modular tone frequencies, which are outputted via the loudspeaker, or wherein the different colors are displayed on an entire area of the color display, or in predetermined partial areas of the color display.

35. The authentication method according to claim 32, wherein the different sound wave combinations are generated through continuous frequency changes, or different individual sound waves or the different sound wave combinations are outputted as discrete sequences, or
wherein the different colors are generated through continuous color changes or the different colors are displayed sequentially as separate colors.

36. The authentication method according to claim 32, wherein the authentication code is generated from at least one of acoustic signals, spoken words, word segments, collocations and sentences.

37. The authentication method according to claim 32, wherein the services comprise at least one of
access to objects or provision of services,
confirmation of payment transactions or bookings,
carrying out transactions or bookings,
access to devices, which include a sound converter and a third acoustic sensor for detecting sound wave compositions, via communication between the sound converter and the third acoustic sensor of the devices, and the loudspeaker and a fourth acoustic sensor for detecting sound wave compositions of the terminal, and
access to devices, which include a display and a fifth optical sensor for detecting colors, via communication between the display and the fifth optical sensor of the devices, and the color display and a sixth optical sensor for detecting colors of the terminal.

38. The authentication method according to claim 32, wherein computation of the sound wave combinations depends on at least one additional quantity which is utilized by a sending device and a receiving device in an identical, conformingly changing manner, so as to limit use of the authentication code to predetermined short time intervals, so that eavesdropping for unauthorized use becomes inconsequential.

39. An arrangement for carrying out an authentication method, comprising:
at least one data processing device,
at least one terminal provided with a loudspeaker or a color display, or both, and
at least one of a first sensor configured for detecting sound waves and a second sensor configured for detecting colors,
wherein the at least one data processing device is connected at least temporarily by data transmission means with the at least one terminal and with the at least one first and second sensor, and
wherein the arrangement is configured to
generate at least one authentication code,
provide first information about the at least one authentication code to at least one user,
generate from the first information with special software installed on the at least one terminal second information which enables the at least one terminal to time-sequentially output different sound wave combinations via the loudspeaker or time-sequentially display different output colors on the color display, or both,
detect with the first sensor the time sequence of the different sound wave combinations or with the second sensor the time sequence of the different colors, or both,
decode with the processing device, which has access to the at least one authentication code, the time sequence of the different sound wave combinations or colors, and compare a result of the decoding with the at least one authentication code, and
unblock use of services depending on an outcome of the comparison.

40. The arrangement according to claim 39, wherein the at least one terminal is a mobile terminal.

41. The arrangement according to claim 39, wherein the at least one data processing device comprises an evaluation unit which decodes the time sequence of the different sound wave combinations or colors, and compares the result of the decoding with the at least one authentication code.

42. The arrangement according to claim 41, wherein the evaluation unit is located at a location of a central computer system, or at a location of the first sensor or of the second sensor.

43. The arrangement according to claim 39, wherein the at least one data processing device is connected via means for data exchange with a device, and wherein the arrangement is configured for controlling the device from the terminal by evaluating the different sound wave combinations or the different colors outputted as a time sequence by the loudspeaker or the color display of the at least one terminal and received by the first and second sensor.

44. A computer program embodied on a computer-readable medium, which program enables a data processing device in cooperation with at least one terminal and with at least one of a first sensor for detecting sound waves and a second sensor for detecting colors, after the program is loaded into storage means of the data processing device, to carry out an authentication method having the steps of
generating at least one authentication code,
providing first information about the at least one authentication code to at least one user,
generating from the first information with special software installed on a terminal second information which enables the terminal to time-sequentially output different sound wave combinations via a loudspeaker or time-sequentially display different output colors on a color display, or both,
detecting with the first sensor the time sequence of the different sound wave combinations or with the second sensor the time sequence of the different colors, or both,
decoding with an evaluation unit, which is connected with at least one of the first and second sensors and has access to the at least one authentication code, the time sequence of the different sound wave combinations or colors, and comparing a result of the decoding with the at least one authentication code, and
unblocking a use of services depending on an outcome of the comparison.

45. Computer-readable storage medium, on which a program is stored which enables a data processing device in cooperation with at least one terminal and with at least one of a first sensor for detecting sound waves and a second sensor for detecting colors, after the program is loaded into storage means of the data processing device, to carry out an authentication method having the steps of
generating at least one authentication code,
providing first information about the at least one authentication code to at least one user,
generating from the first information with special software installed on a terminal second information which enables the terminal to time-sequentially output different sound wave combinations via a loudspeaker or time-sequentially display different output colors on a color display, or both,
detecting with the first sensor the time sequence of the different sound wave combinations or with the second sensor the time sequence of the different colors, or both,
decoding with an evaluation unit, which is connected with at least one of the first and second sensors and has access to the at least one authentication code, the time sequence of the different sound wave combinations or colors, and comparing a result of the decoding with the at least one authentication code, and
unblocking a use of services depending on an outcome of the comparison.

46. The computer program according to claim 45, wherein the data processing device is connected to the data network and the computer program is downloaded from an electronic data network to the data processing device.

47. The computer program according to claim 46, wherein the electronic data network includes the Internet.
